(19) United States
(12) Patent Application Publication
(10) Pub. No.: US 2016/0189576 A1
(43) Pub. Date: Jun. 30, 2016

(54) Abrasive Label System and Method

(71) Applicant: Polly Glasse, Wimberley, TX (US)

(72) Inventor: Polly Glasse, Wimberley, TX (US)

(21) Appl. No.: 14/584,635

(22) Filed: Dec. 29, 2014

(51) Int. Cl. G09F 3/10; G09F 3/02

(52) U.S. Cl. CPC G09F 3/10; G09F 3/02; G09F 2003/0272; G09F 2003/0255

(57) ABSTRACT

A label includes a sheet having an outer side and an inner side, an abrasive attached to the outer side, an adherent attached to the inner side, and a display connected to the sheet. The adherent is fixable to a container and the display is thereby visible towards the outer side.

### TECHNICAL FIELD

The invention generally relates to labels, and more particularly relates to product labels providing an abrasive surface.

### BACKGROUND

A typical label is a printed sign or notice attached to products or a container for products. The label may include a product name or identifier, logos, instructions, as well as information about the product. Conventional labels are paper, polymer, cloth, metal or similar material affixed to a product or container, or may be printed directly on a container or article.

Labels are employed for a variety of reasons, including identifying product, informing about product quantity, source, use, shelf-life and disposal, and alerting to dangers or warnings, among others. Content of labelling may be governmentally regulated, such as can be the case for various food, drugs, and other articles. In any event, labels have typically served merely as a notice or sign to consumers and those obtaining products.

Labels do not typically serve any purpose beyond notification. For example, labels have not been useable for extended or ancillary purposes or those purposes have been very limited. This is because labels have been merely paper, polymer, cloth or similar material fixed to products or containers for notification.

Recently, labels have employed security or mechanical identification mechanisms. For example, radio frequency identification (RFID), antimicrobial, bar code, and other mechanisms may be incorporated in labels; however, purpose of the label remains primarily notification or identity. Moreover, these mechanisms are typically for benefit of other than the ultimate consumer, such as for tracking in distribution channels and the like.

Labels that provide new and additional uses, beyond mere notification, can benefit consumers. Rock climbers, mechanics, cosmetics users, and other consumers of labeled products, would find beneficial a label that serves purpose beyond notification or other conventional purpose. A multi-purpose label, providing notification as well as other function, would therefore be desirable.

### SUMMARY

An embodiment of the invention is a label including a sheet having an outer side and an inner side, an abrasive attached to the outer side, an adherent attached to the inner side, and a display connected to the sheet. The adherent is fixable to a container and the display is thereby visible towards the outer side.

Another embodiment of the invention is a method of manufacturing a label. The method includes providing a sheet having an outer side and an inner side, forming an abrasive attached to the outer side, depositing an adherent attached to the inner side, and printing a display on the sheet.

Yet another embodiment of the invention is a method of manufacturing a label. The method includes providing a sheet having an outer side and an inner side, forming an abrasive attached to the outer side, depositing an adherent attached to the inner side, and dying the sheet to form a display. The abrasive is sufficiently translucent for the display when viewed towards the outer side.

Another embodiment of the invention is a method of manufacturing a label. The method includes providing a sheet having an outer side and an inner side, forming a display comprised of an abrasive attached to the outer side, and depositing an adherent attached to the inner side.

### BRIEF DESCRIPTION OF THE DRAWINGS

The present invention is illustrated by way of example and not limitation in the accompanying figures, in which like references indicate similar elements, and in which:

FIG. 1 illustrates a perspective view of a label including an abrasive outer surface and outward display, for attachment to a wall of a container or other article, according to certain embodiments;

FIG. 2 illustrates a front side view of an abrasive outer surface of a label, according to certain embodiments;

FIG. 3 illustrates an end view of a label with abrasive of the outer surface adherent of the inner side, according to certain embodiments;

FIG. 4 illustrates an end view of a sheet of label, according to certain embodiments;

FIG. 5 illustrates a cross-section along line A-A′ of the label of FIG. 4, of an ink of the outer surface applied to the abrasive of the label, according to certain embodiments;

FIG. 6 illustrates another cross-section along line A-A′ of an alternative label of FIG. 4, of an ink of a sheet covered by the abrasive of the label, according to certain embodiments;

FIG. 7 illustrates a cross-section along line A-A′ of another alternative of the label of FIG. 4, of a dye of a sheet covered by the abrasive of the label, according to certain embodiments;

FIG. 8 illustrates a cross-section along line A-A′ of another alternative of the label of FIG. 4, of a colored or hued abrasive of the label, according to certain embodiments; and

FIG. 9 illustrates a cross-section along line A-A′ of another alternative of the label of FIG. 4, including a matrix or bonded material sheet with covering abrasive of the label, according to certain embodiments.

### DETAILED DESCRIPTION

The following description refers to certain specific embodiments; however, the specific embodiments are merely illustrative and variations and changes may be made in the embodiments without diverting from the broad scope encompassed by the disclosure.

Referring to FIG. 1, a label system 100 includes a sheet 102 having an inner side 104 and an outer side 106. The outer side 106, at least in part, forms an abrasive surface. The outer surface 106 also, at least in part, forms a display 107, which may be printed, dyed, or otherwise disposed on or in the outer surface 106. The inner side 104 forms a surface fixable to an item, such as, for example, a container 108 for a product (e.g., skin moisturizer, balm, or other completely different product), which container 108 may be paper, cardboard, glass, metal or other material.

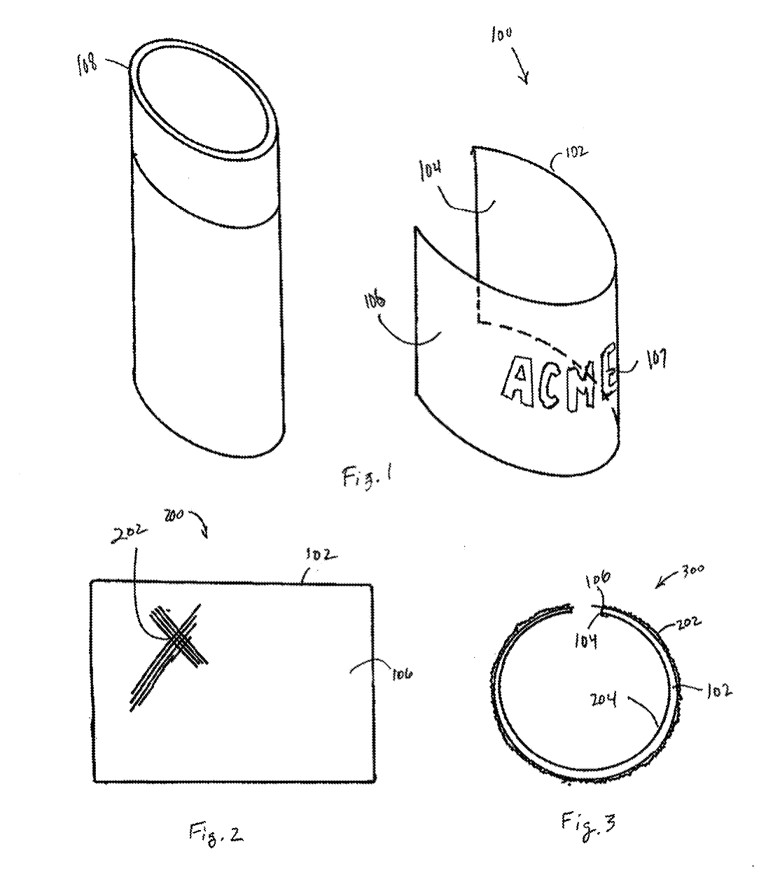

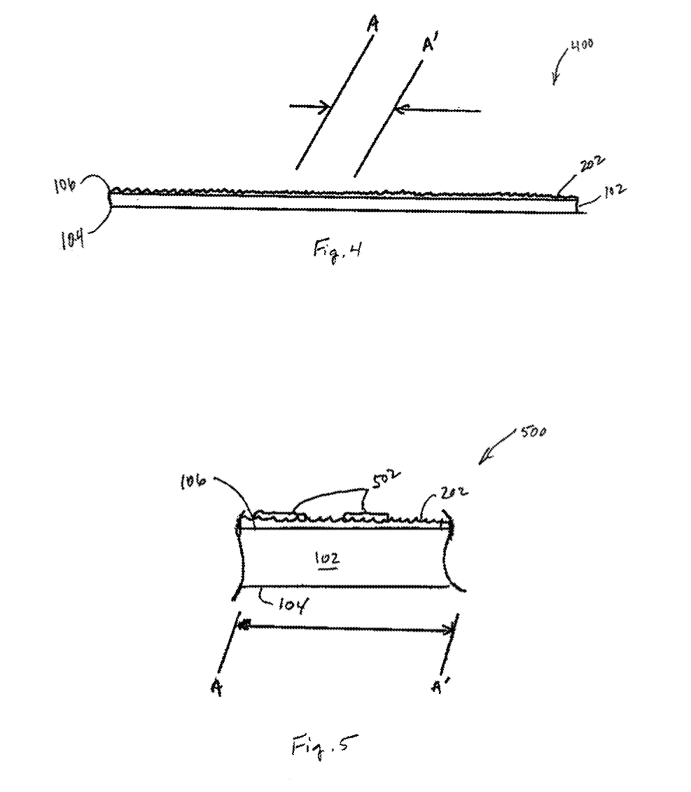

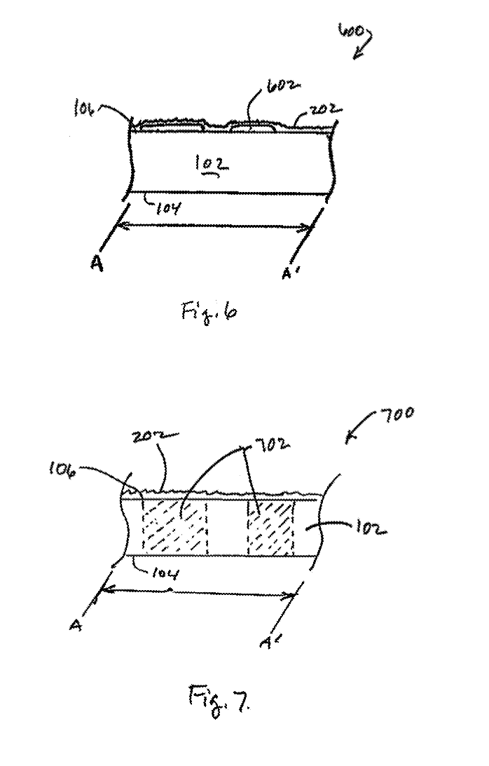

Referring to FIG. 2, in conjunction with FIG. 1, an embodiment of the system 100 includes the sheet 102 of the system 100. An abrasive 202 is formed in the outer surface 106 of the sheet 102. The abrasive 202 is a material useful to shape or finish a workpiece or body part (e.g., finger nails, callouses) through rubbing which leads to filing, scraping, grinding, shaving, trimming, grating, rasping or sloughing away of part of the workpiece or body part (e.g., dead skin cells), as applicable. Suitable materials of the abrasive 202 may, as non-exclusive examples, be granules, such as glass, sand, or other mineral or mineral-like substance such as synthetic stones, striations, such as crisscross valleys and peaks, tooths, such as file or saw features, bonded material, such as an impregnated or other matrix, or other abrasive material. The abrasive 202 may be man-made or not.

Referring to FIG. 3, in conjunction with FIGS. 1 and 2, an embodiment 300 of the system 100 includes the sheet 102 and the abrasive 202 on the outer side 106. The system 100 also may include an adherent 204 on the inner side 104. The system 100 is fixed to the container 108 or other article, for example, on an outwardly disposed container or article surface, via the adherent 204. As so fixed to the container 108 or other article, the article supports the inner side 104, thereby supporting the outer side 106 for use of the abrasive 202 for shaping and finishing.

The outer side 106 of the system 100 further includes a display 107. The display 107 is, for example, a printed or dyed product name and/or information of or integral to the sheet 102 and/or abrasive 202 as hereafter disclosed. The system 100 may be planar, curled or other configuration for application. The system 100 may also be any shape or size, such as for example, but not limitation, round, square, hexagonal, triangular, large, small or other. The size or shape may be limited by the shape or configuration of the container 108 or other article to which the system 100 is applied.

Referring to FIG. 4, another embodiment of the system 100 includes a planar sheet 102 having an outer side 106 and an inner side 104. The outer side 106 forms the abrasive 202. The abrasive 202 may be relatively uniform in texture, or may include segments or portions of varying texture.

In operation, the system 100 is fixed by attachment to the container 108 or other article via the adherent 204 of the inner side 104. The adherent 204 may be glue or other adhesive material placed or formed on the inner side 104. In certain embodiments, the sheet 102 is made available with the adherent 204, such as, for example, the adherent 204 is placed on the inner side 104 and covered by a removable pane or film. In such embodiments, the pane or film is removed prior to connectedly affixing the sheet 102 to the container 108 or other article by the adherent 204. The adherent 204 may form a substantially permanent or removable label on the container 108 or other article.

As fixed to the container 108 or other article, the system 100 is a label of the display 107, showing product name, information, or other desired content. In addition to operation as the label display, the abrasive 202 provides a shaping or forming surface for a workpiece or body part, such as finger nail or callous. In use, the abrasive 202 is rubbed on a surface for shaping or forming the surface by sloughing, filing, scraping, grinding, or shaving away or removing the surface. As may be understood, variation of the abrasive 202, such as for a more or less rough surface of the system 100, provides for different possible uses of shaping or forming, such as with different workpiece or body part.

In non-exclusive embodiments, the abrasive 202 may be wholly or partially located on the outer side 106 of the sheet 102. For example, the entire outer side 106 may include the abrasive 202, or otherwise a part, portion or segment of the outer side 106 may include the abrasive 202.

Referring to FIG. 5, a non-exclusive embodiment 500 of the system 100, in partial section, includes the sheet 102 and the abrasive on the outer side 106. The inner side 104 may include the adherent 204. For the display 107 for use as a label, ink 502 deposits are located on abrasive 202. In the embodiment 500, the abrasive 202 may be opaque or translucent and will not block or obscure the display 107 of the ink 502. Although the ink 502 is illustrated as deposited in only part(s) or portion(s) of the exposed abrasive 202, the ink 502 may, in fact, be deposited across the entire abrasive 202 or in part, as desired.

Referring to FIG. 6, another non-exclusive embodiment 600 of the system 100, in partial section, includes the sheet 102. The outer side 106 of the sheet 102 includes ink 602 deposits, overlaid by the abrasive 202. In the embodiment, the abrasive 202 must be relatively translucent to allow the display 107 of the ink 602 as a label. Although the ink 602 is illustrated as deposited in only part(s) or portion(s) of the outer side 106 of the sheet 102, the ink 502 may, in fact, be deposited across the entire sheet 102 or in part, as desired.

Referring to FIG. 7, yet another non-exclusive embodiment 700 of the system 100, in partial section, includes the sheet 102 and the abrasive 202 on the outer side 106. The sheet 102 is dyed 702 or otherwise colored to provide the display 107 as a label. In the embodiment, the abrasive 202 must be sufficiently translucent to allow visibility of the display 107 of the dye 702 through the abrasive 202. Although the dye 702 is illustrated in only parts of the sheet 102, the dye 702 may be over entirety or only portion(s) of the sheet 102.

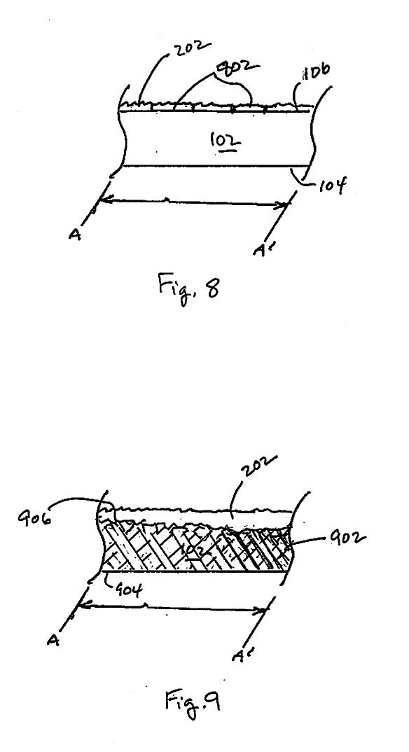

Referring to FIG. 8, in another embodiment 800 of the system 100, the abrasive 202 provides color or hue as the display 107. In the embodiment 800, the sheet 102 is covered on the outer side 106 by the abrasive 202. The abrasive 202 includes segments or portions 802 of varied color or hue. Because different (or possibly same) materials are possible for the abrasive 202, selection may be made among the materials in order to provide the differing color or hue desired for the display 107. In such embodiment, the abrasive 202 provides the display 107 of the label because of the segments or portions 802.

Referring to FIG. 9, another embodiment 800 includes a matrix or bonded material 902 as the sheet 102. The matrix or bonded material 902 may be embedded or covered with the abrasive 202, or alternately, though not shown in the figure, the material 902 may itself be the abrasive 202 on the outer side 906 of the material. The inner side 904 of the material 902 may include the adherent 204 (not shown in detail). In the embodiment 800, the matrix or bonded material 902 may include ink, dye or color elements serving as the display 107. In such case, any abrasive 202 overlaying the outer side 906 may be sufficiently translucent to provide the display 107 as the label. Alternately, the abrasive 202 may include color or hue, or ink or dye may be overlaid the abrasive 202. As will be understood, variations of the display 107 provided for the matrix or bonded material 902 are possible in accordance with various others of the embodiments.

Numerous variations in the foregoing are possible. Inks, dyes, abrasive, or other display may be any of a wide variety of colors and combinations of colors. For example, the sheet may be one or more color and inks or dyes may provide one or more different colors to the display. The material of the abrasive may be widely varied, including both natural and man-made materials. Same or different abrasives may be employed and more than one type of abrasive may be combined either in segments or within segments. Adherent may be applied or included in the label system. A variety of adherents, and various combinations thereof, may be employed to achieve desired tacking of labels to a surface, such as a container or other article. In certain alternatives, labels are pre-sized and/or pre-shaped for application or formed of a larger or continuous sheeting and cut or otherwise shaped and sized. Label sizes vary widely, and labels may include perforations or similar for label removal (e.g., for peel off of product information or indicators) or twist break (e.g., twist off cap that would break the label). Where the sheet is a matrix or bonded material, the material may itself, in certain alternatives, serve as the abrasive, and the material may have color or hue forming the display or else ink or dye may be printed or otherwise deposited or impregnated on or in the material.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A label, comprising:
a sheet having an outer side and an inner side;
an abrasive attached to the outer side;
an adherent attached to the inner side; and
a display connected to the sheet;
wherein the adherent is fixable to a container and the display is thereby visible towards the outer side.

2. The label of claim 1, wherein the display is ink deposited directly on the outer side and the abrasive is sufficiently translucent for display of the ink when viewing towards the outer side.

3. The label of claim 1, wherein the display is ink deposited directly atop the abrasive attached to the outer side of the sheet and outwardly displays when viewing towards the outer side.

4. The label of claim 1, wherein the display is dye of the sheet and the abrasive is sufficiently translucent for display of the dye when viewing towards the outer side.

5. The label of claim 1, wherein the display is formed by the abrasive.

6. The label of claim 5, wherein the sheet is a matrix material.

7. The label of claim 6, wherein the matrix material is the abrasive.

8. The label of claim 6, wherein the display is printed on the matrix and the abrasive is sufficiently translucent for display of the ink when viewing towards the outer side.

9. The label of claim 1, further comprising:
perforations extending through sheet.

10. The label of claim 1, wherein the sheet is a laminate.

11. A method of manufacturing a label, comprising:
providing a sheet having an outer side and an inner side;
forming an abrasive attached to the outer side;
depositing an adherent attached to the inner side; and
printing a display on the sheet.

12. The method of claim 11, wherein the step of printing deposits ink atop the abrasive.

13. The method of claim 11, wherein the step of printing deposits ink on the sheet and the abrasive is sufficiently translucent for the display of the ink when viewed towards the outer side.

14. A method of manufacturing a label, comprising:
providing a sheet having an outer side and an inner side;
forming an abrasive attached to the outer side;
depositing an adherent attached to the inner side; and
dying the sheet to form a display;
wherein the abrasive is sufficiently translucent for the display when viewed towards the outer side.

15. A method of manufacturing a label, comprising:
providing a sheet having an outer side and an inner side;
forming a display comprised of an abrasive attached to the outer side; and
depositing an adherent attached to the inner side.

16. The method of claim 15, wherein the sheet is a matrix material.

17. The method of claim 16, wherein the matrix material is the abrasive.

18. The method of claim 16, wherein the display is printed on the matrix material and the abrasive is sufficiently translucent for the display when viewed towards the outer side.

19. The method of claim 11, further comprising:
perforating the sheet.

20. The method of claim 11, wherein the sheet is a laminate.
